(19) United States
(12) Patent Application Publication
(10) Pub. No.: US 2009/0225633 A1
(43) Pub. Date: Sep. 10, 2009

(54) Wristwatch

(76) Inventor: Jean-Pierre Lepine, Saint Lupicin (FR)

Correspondence Address: CONNOLLY BOVE LODGE & HUTZ LLP, 1875 EYE STREET, N.W., SUITE 1100, WASHINGTON, DC, 20006, US

(21) Appl. No.: 10/526,666

(22) PCT Filed: Sep. 5, 2003
(86) PCT No.: PCT/FR03/02653

§ 371 Date: Nov. 4, 2008

(30) Foreign Application Priority Data
Sep. 5, 2002 (FR) 0211025

(51) Int. Cl. G04B 37/14

(52) U.S. Cl. 368/282

(57) ABSTRACT

A wrist watch includes a watch case main and a removable strap. Each end of the strap is solidly connected to respective free ends of two linking elements that are solidly connected to the main. Each linking element is mounted so that it can move in relation to the main and the free end of each linking element can be oriented in different directions.

### FIELD OF THE INVENTION

The present invention relates to a watch bracelet designed to be worn on a wearer's wrist.

### BACKGROUND OF THE INVENTION

As its name indicates, a watch bracelet is a watch mounted on a bracelet that can be made, for example, in leather, in metal, or in plastic. Such a watch bracelet is essentially made of a watch case containing a watch movement as well as a detachable bracelet for which the ends are fixed in a removable manner to the central portion of the watch case, hereinafter referred to as a middle. The case is generally equipped with two pairs of lugs forming connection elements that are respectively connected at two opposing sides to the watch case middle, and which extends in the same direction but in opposite senses. The free end of each lug generally includes a bore designed to receive the end of a telescoping pin generally referred to as a push pin, that is itself connected to the bracelet ends.

This type of watch bracelet is inconvenient and not always very comfortable to the wearer since it presents a part having dimensions that are relatively important, these being rigid structures that do not permit the watch bracelet to easily adapt to the size of a wearer's wrist. This rigid part corresponds to the watch case main section (main) combined with the two pairs of connection lugs. Clearly, these are essentially two pairs of lugs, disposed in cantilevered fashion from the watch case main section, that generally have an excessive length at the rigid part of the watch bracelet.

### BRIEF DESCRIPTION OF THE INVENTION

Thus, the technical problem resolved by the primary object of the present invention is to offer a watch bracelet including a main case section and a removable bracelet, each bracelet end being connected at its free ends, respectively, to two connection elements connected to the main, the watch bracelet avoiding problems of the state of the current art and being able to adapt better to the body contour of the wearer, while offering improved use comfort.

The solution to the technical problem consists in accordance with the present invention in providing each connection element as an element moveably mounted in relation to the watch case main, the free ends of each element being suitable to be oriented in different directions.

The invention thus defines an advantage in reducing the dimensions of the rigid part of the watch bracelet. In effect, the overhanging connection elements are not connected in a rigid manner to the watch case main section. Due to their relative mobility, each connection element is naturally oriented and follows a reasonable tangential direction to the curve of the wearer's wrist. The set formed by the main and the connection elements therefore provide a structure that is sufficiently flexible to accommodate in a superior manner the wearer's wrist, and improves comfort substantially.

Additional characteristics will emerge during the course of the following description which can be considered on its own or in reasonable technical combinations.

The description is not limited to the title but will be better understood by referring to the following drawings:

### BRIEF DESCRIPTION OF THE DRAWINGS

FIG. 1 is a top plan view of a watch bracelet in accordance with the present invention.

FIG. 2 is a disassembled view showing in detail the main section of the watch case and the connecting elements of the watch bracelet as shown assembled in FIG. 1.

FIG. 3 represents a side elevational view showing the watch bracelet of FIG. 1.

FIG. 4 is a top view of the watch bracelet shown in FIG. 1, illustrating certain mobility characteristics of the connection elements when the bracelet is not connected to the main.

FIG. 5 is a bottom view of the watch bracelet shown in FIG. 4.

### DETAILED DESCRIPTION OF THE INVENTION

For reasons of clarity, the same numbered elements are designated by identical reference numbers in all of the views. Further, only the essential elements, necessary for an understanding of the invention have been shown without respect for actual scale and in a schematic manner.

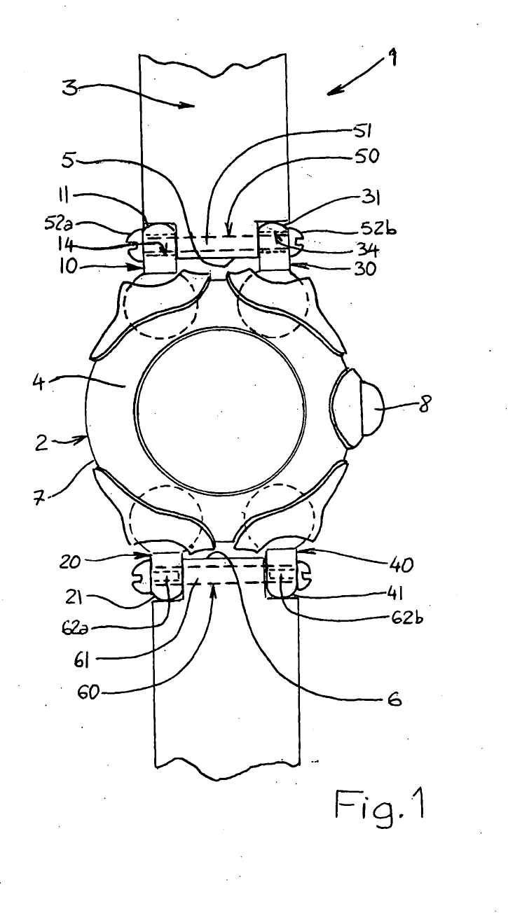

FIG. 1 illustrates a watch bracelet 1 that essentially comprises a case 2 for a dial and a removable bracelet 3. In a classical manner, the case 2 includes a main section 4, hereinafter referred to as the main 4, the latter housing a watch movement that is not illustrated in the figures for purposes of clarity. The ends 5, 6 of the bracelet 3 are removably connected to the main 4 by an intermediary structure, notably two pairs of connection elements 10, 30; 20, 40 that are respectively disposed in opposition on the boundary 7 of the main 4. It is also noticed that a crown 8 is present.

Conforming to the object of the present invention, each connection element 10, 20, 30, 40 is movably mounted in comparison to the main 4. The free end 11, 21, 31 41 of each connection element 10, 20, 30, 40 is also capable of being oriented in different directions. In the illustrated example, each connection element 10, 20, 30, 40 is joined so as to extend in all possible directions that generate a cone having its peak situated in the main 4.

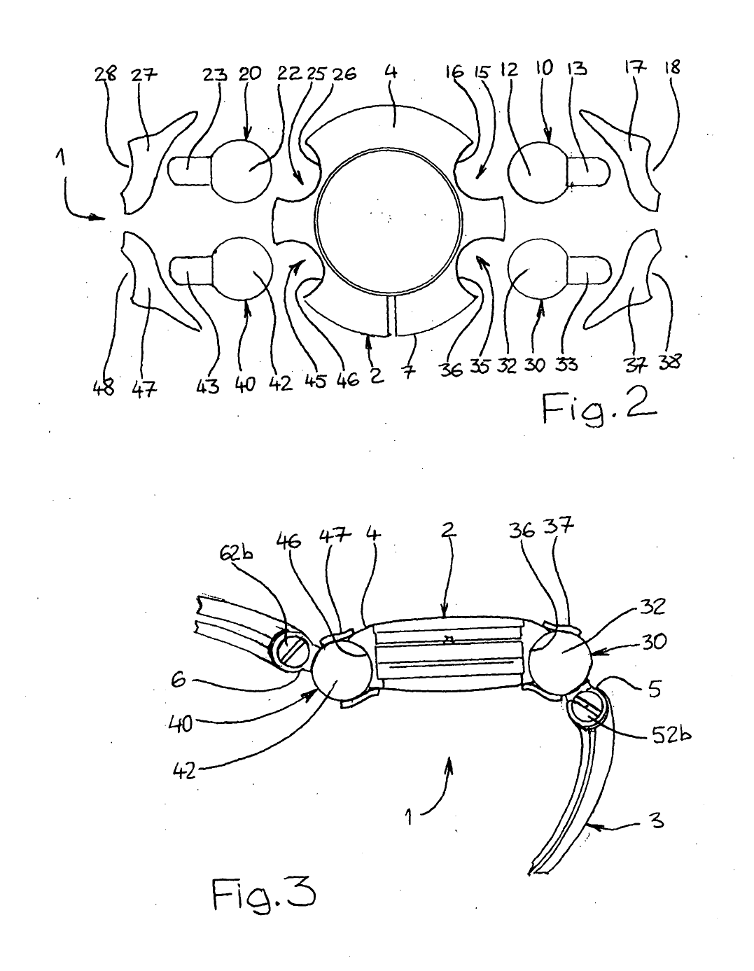

The watch of FIG. 2 shows that each connection element 10, 20, 30, 40 includes a spherical part 12, 22, 32, 42 forming a ball and socket so that each radial part 13, 23, 33, 43 creates a first assembly means 14, 24, 34, 44. The spherical part 12, 22, 32, 42 is fitted so as to enable movement in a concave recess 15, 25, 35, 45 forming a seat. The first means of assembly 14, 24, 34, 44 is itself configured in a manner to cooperate by connection with a second means of assembly 50, 60 connected to the free end 5, 6 corresponding to bracelet 3.

Following one example of the invention, the concave receptacle 15, 25, 35, 45 includes, on the one hand a hemispheric cavity 16, 26, 36, 46 formed in the main 4, and on the other hand, by a removable clevis 17, 27, 37, 47 the internal face of which presents a complementary form of the spherical part 12, 22, 32, 42 since the spherical part 12, 22, 32, 42 is located in the hemispherical cavity 16, 26, 36, 46. The clevis 17, 27, 37, 47 includes an opening 18, 28, 38, 48 permitting the passage of the radial part 13, 23, 33, 43 and consequently the corresponding mobility of the connection element 10, 20, 30, 40.

In accordance with another aspect of the invention, each clevis 17, 27, 37, 47 is connected on the main 4 by connecting screws that are not represented on the different figures, again this being to enhance clarity.

In a particularly advantageous manner, each connection element 10, 20, 30, 40 benefits from different mobilities. Therefore, and as one can see from FIG. 3, each connection element 10, 20, 30, 40 can tilt vertically up to about 90°. In this particular example, each connection element 10, 20, 30, 40 is more precisely able to tilt vertically in comparison with the plane of the watch bracelet to about 30° toward the top as in the case of the connection element 40, and up to about 60° toward the bottom as for the connection element 30.

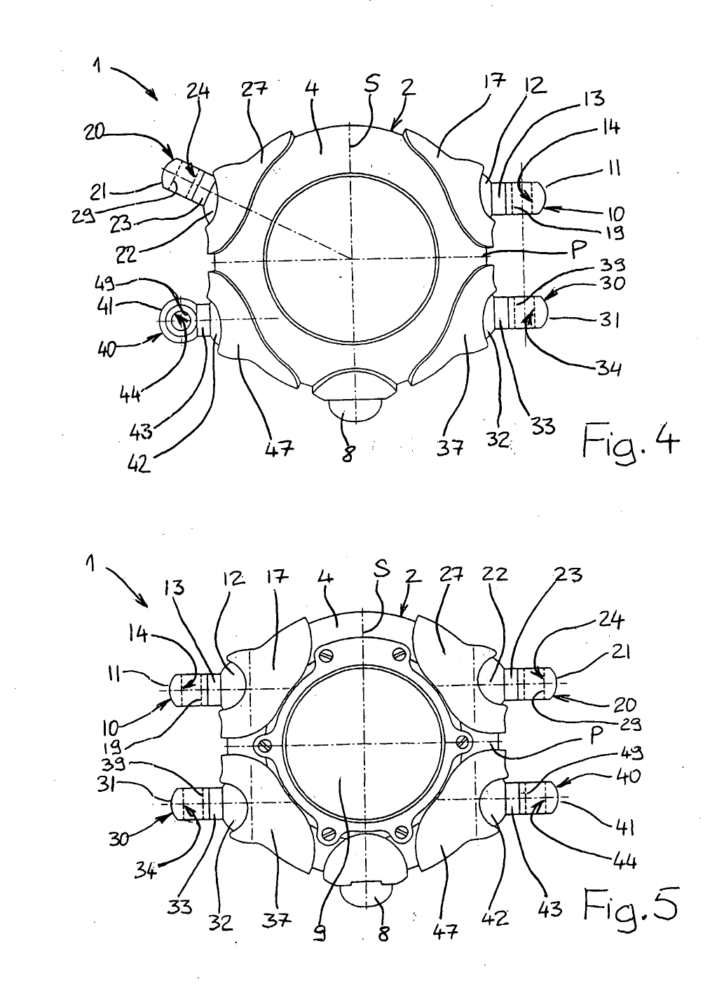

Regarding FIG. 4, each connection element 10, 20, 30, 40 is also capable of horizontal tilt to about 35°. In this particular example, each connection element 10, 20, 30, 40 is horizontally tiltable to about 5° toward the interior and 30° toward the exterior, in comparison to a plane P that is orthogonal to the plane of the watch bracelet 1, on the one hand, and orthogonal to the sagittal plane S passing through the crown, on the other hand. This characteristic is particularly advantageous to compensate for the eventual assembly effect that can exist between the first means of an assembly 14, 24, 34, 44 and the second associated assembly means 50, 60.

As also shown in FIG. 4, each connection element 10, 20, 30, 40 is also able to turn axially about itself, that is to say around the direction in which the connection element 10, 20, 30, 40 extends.

FIGS. 1, 4 and 5 also evidence the nature of the structure of each first means of assembly 12, 24, 34, 44 and of each second means of assembly 50, 60. In this example, each first means of assembly 14, 24, 34, 44 is comprised of a pass through bore forming a connecting bearing 19, 29, 39, 49 by cooperating with the connection pin 51, 61, forming a second means of assembly 50, 60. Each connection pin 51, 61 is located in two corresponding bearings 19, 39; 29, 49 by the intermediary of two set screws 52a, 52b; 62a, 62b, forming stops with the respective ends of each connection pin 51, 61. All the known assembly means and equivalents to those relating to the first means of assembly 14, 24, 34, 44 and to the second connection means 50, 60, can evidently be adopted for the assembly function to be fulfilled.

FIG. 5 shows more specifically the lower part of each clevis 17, 27, 37, 47. It equally permits the observation of the presence of a bottom 9 that provides access to the interior of the watch case 2, at the underside of the watch bracelet 1. This bottom is connected to the lower edge of the main by a set of screws.

1. A watch bracelet (1) including a watch case main (4) and a removable bracelet (3), each end (5, 6) of the bracelet (3) being connected to free respective ends (11, 31; 21, 41) of two connection elements (10, 30; 20, 40) that are connected to the main 4, characterized in that each connection element (10, 20, 30, 40) is movably mounted for displacement in relation to the main 4, the free end (11, 21 31, 41) of each connection element (10, 20, 30, 40) being capable of being oriented in different directions.

2. A watch bracelet (1) according to claim 1, characterized in that each connection element (10, 20, 30, 40) is capable of tilting vertically to about 90°.

3. A watch bracelet (1) according to either claim 1 or 2 characterized in that each connection element (10, 20, 30, 40) is capable of tilting vertically up to about 30° toward the top and about 60° toward the bottom, relative to a plane of the watch bracelet (1).

4. A watch bracelet (1) according to any one of claims 1 to 3, characterized in that each connection element (10, 20, 30, 40) is capable of tilting horizontally to about 35°.

5. A watch bracelet (1) according to any one of the claims 1 to 4, characterized in that each connection element (10, 20, 30, 40) is capable of horizontally tilting to about 5° toward the interior and about 30° toward the exterior, in relation to a plane (P) that is orthogonal to the plane of the watch bracelet (1) on the one hand and on the other hand orthogonal to the sagittal plane (S) passing through the crown (8).

6. A watch bracelet (1) according to any one of the claims 1-5, characterized in that each connection element (10, 20, 30, 40) is capable of turning axially around the direction in which the connection element (10, 20, 30, 40) extends.

7. A watch bracelet (1) according to any one of the claims 1-6 characterized in that each connection element (10, 20, 30, 40) comprises a spherical part (12, 22, 32, 42) forming a ball joint and a radial part (13, 23, 33, 43) resulting in a first assembly means (14, 24, 34, 44), the spherical part (12, 22, 32, 42) being capable of turning in a recess (15, 25, 35, 45) forming a seat, and the first assembly means (14, 24, 34, 44) being capable of cooperating by securement with a second assembly means (50, 60), connected at corresponding free end of the bracelet.

8. A watch bracelet (1) according to any one of claims 1-7 characterized in that the recess (15, 25, 35, 45) includes on the one hand, a generally hemispherical cavity (16, 26, 36, 46) housed in the main (4), and on the other hand by a removable clevis (17, 27, 37, 47), the internal face of which presents a generally complementary form for the spherical part (12, 22, 32, 42) when the spherical part (12, 22, 32, 42) is received in the cavity (16, 26, 36, 46), the clevis (17, 27, 37, 47) including an opening (18, 28, 38, 48) permitting the passage of the radial part (13, 23, 33, 43) to achieve corresponding mobility of the connection element (10, 20, 30, 40).

9. A watch bracelet (1) according to claim 8 characterized in that each clevis (17, 27, 37, 47) is connected onto the main (4) by screws.

10. A watch bracelet (1) according to any one of claims 7-9 characterized in that each first assembly means (14, 24, 34, 44) comprises a pass through bore, forming a bearing (19, 29, 39, 49), this is capable of cooperating with a connection pin (51, 61) forming second assembly means (50, 60).

11. A watch bracelet (1) according to claim 10 characterized in that each connection pin (51, 61) is connected to two corresponding bearings (19, 39; 29, 49) by two intermediary set screws (52a, 52b; 62a, 62b) forming a stop at the respective ends of the connection pin (51, 61).
